(19) United States
(12) Patent Application Publication
(10) Pub. No.: US 2026/0083612 A1
(43) Pub. Date: Mar. 26, 2026

(54) MULTI-FUNCTION JOINT REHABILITATION AND EXERCISE APPARATUS

(71) Applicant: Peleos Technologies LLC, Sarasota, FL (US)

(72) Inventors: Nicole Elizabeth Samec, Sarasota, FL (US); Chun-Yuh Huang, Miami, FL (US); Brian Levy, Ruskin, FL (US); Stephen Berryman, Pembroke Pines, FL (US); Damon Jeriko Andrew Blais, Surrey BC (CA)

(21) Appl. No.: 18/896,243

(22) Filed: Sep. 25, 2024

Related U.S. Application Data
(60) Provisional application No. 63/585,376, filed on Sep. 26, 2023.

(51) Int. Cl. A61H 1/02

(52) U.S. Cl. CPC A61H 1/0237; A61H 2201/1633; A61H 2201/5007; A61H 2201/5061; A61H 2201/5064; A61H 2201/5069; A61H 2201/5097

(57) ABSTRACT

A multi-function joint rehabilitation and exercise apparatus includes a device having an assembly for accommodating a lower limb extremity such that said lower limb extremity rests securely within said assembly, an electric motor for applying force against lower limb extremity movement about the user's joint, an electric motor for moving the user's lower extremity, and an electric motor for applying force to the user's joint, sensors embedded in the device, including a sensor for measuring force, a sensor for measuring position, and a sensor for measuring an angle, and a computing device including at least a processor and a memory, the computing device configured for collecting measurement data from the sensors, storing said measurement data and transmitting the measurement data during and after use of the apparatus by the user.

### CROSS REFERENCE TO RELATED APPLICATIONS

This patent application claims priority to provisional application number 63585376 filed Sep. 26, 2023 and titled “Multi-function joint rehabilitation and exercise apparatus. ” The subject matter of patent application number 63585376 is hereby incorporated by reference in its entirety.

### STATEMENT REGARDING FEDERALLY SPONSORED RESEARCH DEVELOPMENT

This invention was made with government support under contract number W81XWH-15-9-0001 awarded by the United States Army Medical Research and Development Command. The government has certain rights in the invention.

### INCORPORATION BY REFERENCE OF MATERIAL SUBMITTED ON A COMPACT DISC

Not applicable.

### TECHNICAL FIELD

The technical field relates generally to medical devices and more specifically to new medical devices and methods for rehabilitating a joint or limb.

### BACKGROUND

In the realm of medical science, conditions affecting the lower extremities—such as knee injuries, joint diseases, ankle injuries, and lower leg disorders—alongside musculoskeletal injuries, present a pervasive issue. These conditions not only induce pain but also impair the function of the knee and lower extremity and can culminate in disability. The first line of treatment often recommended for these ailments is rehabilitation, with the objective of restoring full bodily function and alleviating symptoms like pain and stiffness.

Physical and occupational therapy programs serve as indispensable elements in the rehabilitation process. These programs aim to restore function through interventions designed to regain mobility, such as muscle strength and balance, as well as range of motion. The benefits of physical and occupational therapy extend to reducing pain, stiffness, and disability in patients with musculoskeletal conditions, thereby enhancing their quality of life.

Early rehabilitation has been shown to expedite recovery in early phases following injury onset, enabling earlier return to sports, operational service, and training. Time is pivotal as treatment delays will cause inadequate healing and scar tissue to form, potentially leading to long-term disability, chronic pain, or costly invasive procedures.

Access to care and delay in and discontinuity of care are ongoing issues for patients in rural settings and military members and families and can subsequently cause poorer health outcomes. These transient services and remote settings cause fragmented care, inconsistency in treatment, and increase long-term medical costs. In many cases, patients travel to another city to have surgery and then return home after surgery where physical therapy services aren't always available.

Further, practice variations on the optimal amount and composition of rehabilitation services are widely known. These variations are cited as a potential source of outcome variability and excessive healthcare costs. Notably, there's substantial variation not only in rehabilitation patterns and preferences but in exercise content and timing, particularly in regard to the criteria for progressing patients to unrestricted sports.

Additionally, many measurement tools and methods used to assess lower extremity and knee health are subjective and not repeatable or reproducible. These tools may generate inaccurate and unreliable information upon for clinical and return to duty or return to sports decisions. Patients rarely have metrics or external feedback provided during rehabilitation exercises. Thus, there is a need for alternative approaches that can expands the footprint of care into temporary duty or remote settings (e.g., training, deployments, rural), individualize care to each patient, and quantitatively monitors therapy and reports results to patients and providers.

Osteoarthritis stands as the most prevalent joint disorder and a leading contributor to disability and pain among adults. Alarmingly, opioids are prescribed at a disproportionate rate for Osteoarthritis patients, with a significant percentage relying on these drugs as their primary means of pain management. The chronic use of nonsteroidal anti-inflammatory drugs also poses risks, including the development of peptic ulcer disease and renal dysfunction. Given these concerns, there is an urgent need for alternative approaches to pain management in Osteoarthritis and musculoskeletal injuries in general. Manual therapy, specifically joint manipulation and joint mobilization, has been demonstrated to be effective in modulating pain, increasing range of motion, and reducing inflammation, particularly in patients diagnosed with knee Osteoarthritis. Early intervention post-diagnosis can significantly mitigate or prolong the need for joint replacement surgeries.

Post-traumatic Osteoarthritis represents another major cause of disability and poses a significant health and economic burden. Unlike degenerative Osteoarthritis, post-traumatic Osteoarthritis is characterized by a triggering event that causes injury to the articular cartilage. The period immediately following this injury offers a window for interventions that could potentially prevent the degradation of articular cartilage and the subsequent development of post-traumatic Osteoarthritis. Research indicates that early intervention can alleviate detrimental cellular and molecular responses, such as cell death and the elevation of pro-inflammatory mediators.

Muscle weakness in the lower extremities, particularly in the quadriceps, often persists long after a knee injury has occurred. This weakness can severely impact daily activities and can lead to instability when walking on uneven surfaces. Physical and occupational therapy that targets these deficits is crucial for a safe return to full activity.

Limited range of motion in the knee, hip, and ankle can also adversely affect one's ability to perform daily activities and engage in high-level activities like running or jumping. Manual therapy techniques have been shown to be effective in increasing range of motion, modulating pain, and reducing inflammation. These techniques are comparable in efficacy to nonsteroidal anti-inflammatory drugs, making them suitable pharmaceutical alternatives.

Current treatments for knee Osteoarthritis are largely focused on symptom and functional management, often involving addictive pharmaceuticals and surgeries. These approaches are limited by issues such as access, compliance, and cost. Moreover, no existing therapeutic intervention effectively halts the structural deterioration of articular cartilage.

Therefore, there is a pressing need for innovative solutions that not only manage symptoms but also modify the progression of the disease. Consequently, a need exists for improvements over the prior art, and more particularly for rehabilitation and exercise devices that offer more and improved functions.

### SUMMARY

A multi-function joint rehabilitation and exercise apparatus is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

A multi-function joint rehabilitation and exercise apparatus includes a device comprising an assembly for accommodating a lower limb extremity such that said lower limb extremity rests securely within said assembly, an electric motor for applying force against lower limb extremity movement about the user's joint, an electric motor for moving the user's lower extremity, and an electric motor for applying force to the user's joint, a plurality of sensors embedded in the device, including at least a sensor for measuring force, a sensor for measuring position, and a sensor for measuring an angle, and a computing device comprising at least a processor and a memory, the computing device configured for collecting measurement data from the plurality of sensors, storing said measurement data, and transmitting said measurement data during and after use of the apparatus by the user.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1A is an illustration of a left side view of an exemplary multi-function joint rehabilitation and exercise apparatus, according to an example embodiment;

FIG. 1B is an illustration of a right side view of the multi-function joint rehabilitation and exercise apparatus, according to an example embodiment;

FIG. 1C is an illustration of a rear view of the multi-function joint rehabilitation and exercise apparatus, according to an example embodiment;

FIG. 1D is an illustration of a frontal view of the multi-function joint rehabilitation and exercise apparatus, according to an example embodiment;

FIG. 1E is an illustration of a right side perspective view of the multi-function joint rehabilitation and exercise apparatus, according to an example embodiment;

FIG. 1F is an illustration of a left side perspective view of the multi-function joint rehabilitation and exercise apparatus, according to an example embodiment;

FIG. 1G is a block diagram showing the components of the exemplary multi-function joint rehabilitation and exercise apparatus, according to an example embodiment.

FIG. 2 is a block diagram showing data flow of utilization of the multi-function joint rehabilitation and exercise apparatus, according to one embodiment.

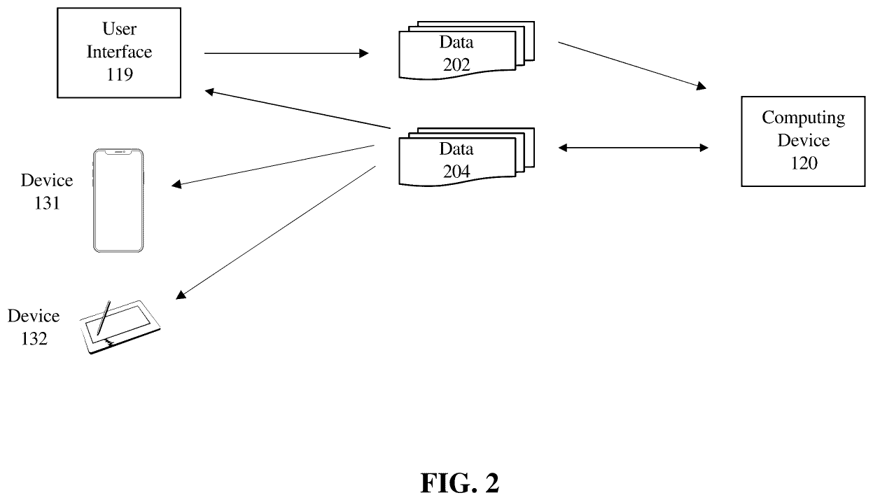

FIG. 3 is a flow chart depicting the general control flow of a process for utilizing the multi-function joint rehabilitation and exercise apparatus, according to one embodiment.

FIG. 4 is a block diagram depicting a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a multi-function joint rehabilitation and exercise apparatus that provides range of motion exercises for users, strengthening exercises (open kinetic chain and closed kinetic chain), stretching, joint manipulation, joint mobilization, weight-bearing exercises, force feedback features, as well as data logging, storage, and transmittal. The claimed subject matter allows for the logging of various types of data using a mixture of sensors in a novel and improved fashion. The claimed subject matter also improves over the prior art by allowing for said data to be transmitted to a computing device for further analysis by a medical professional or other automated systems. The claimed subject matter also improves over the prior art by allowing for said data to deliver “smart” exercises through closed loop monitoring and exercise parameter adjustments.

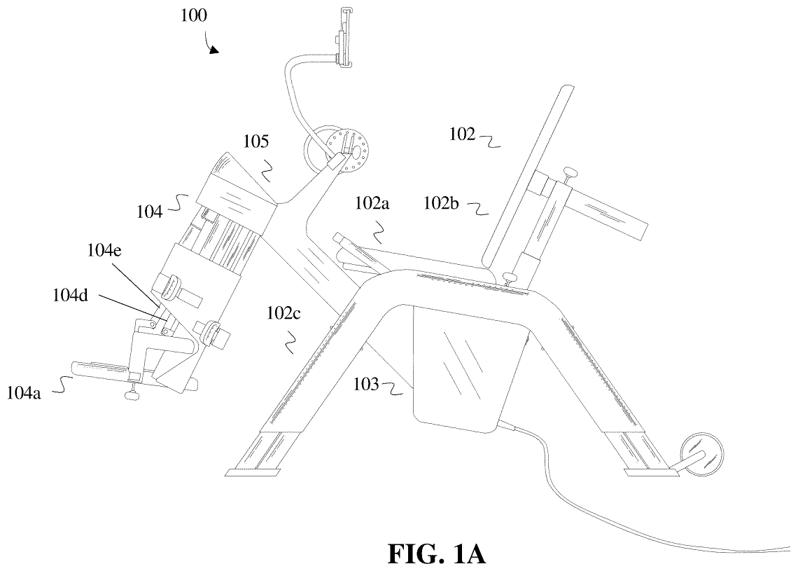

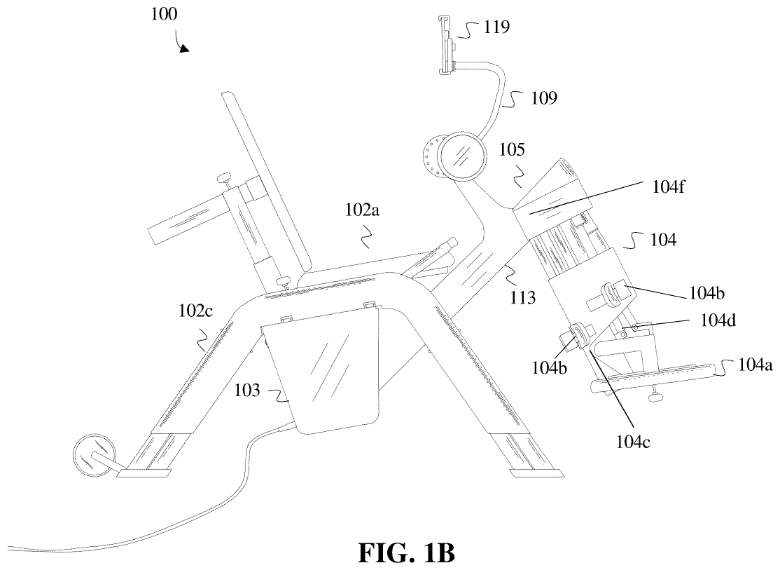

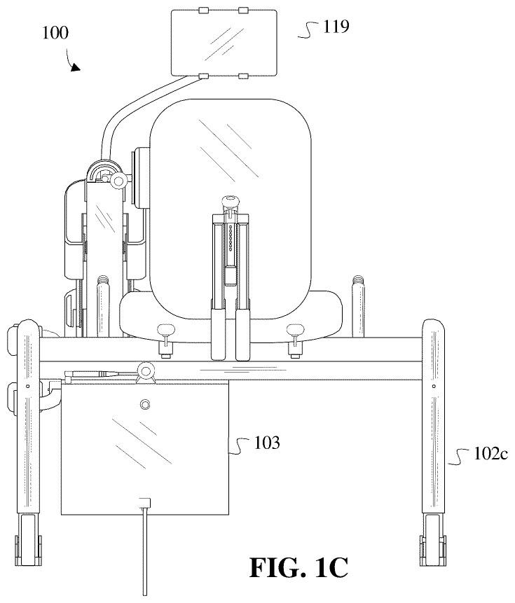

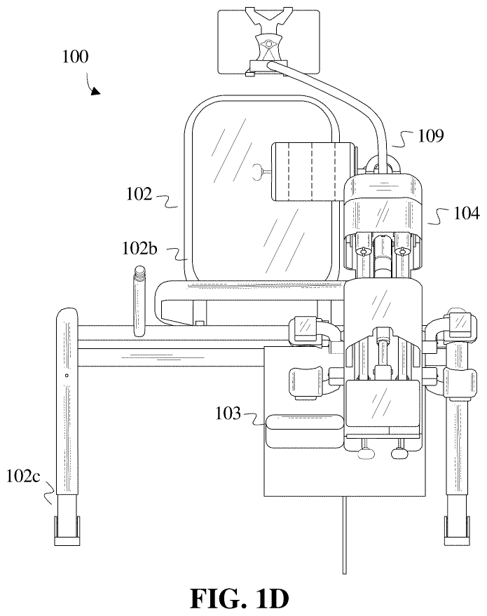

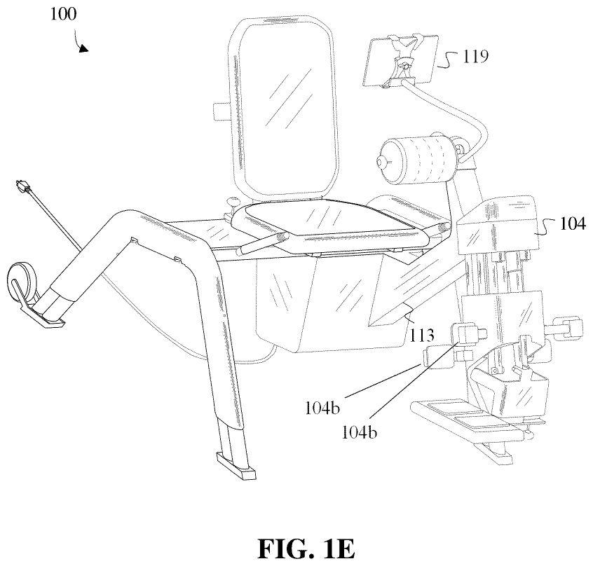

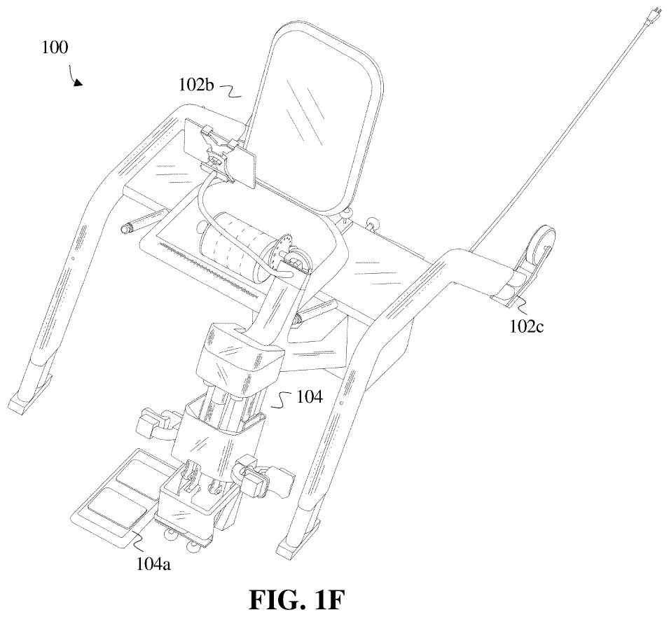

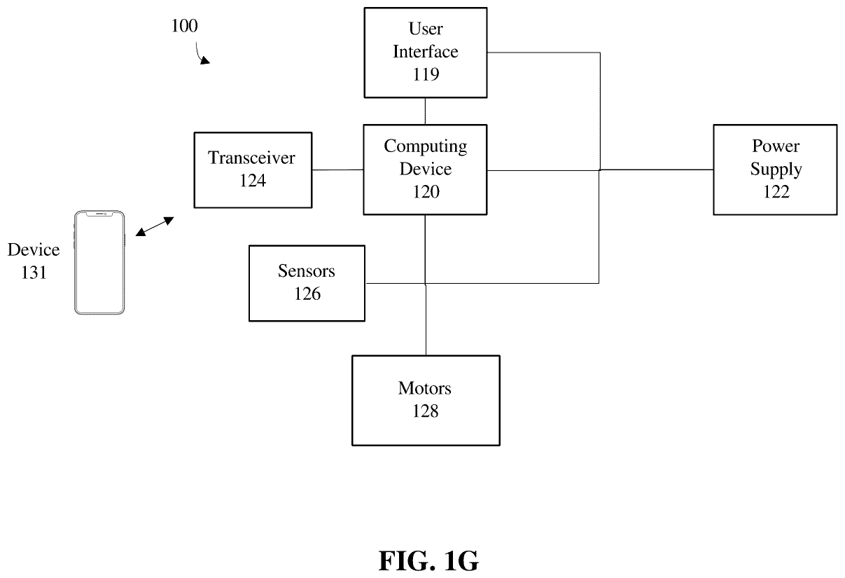

The multi-function joint rehabilitation and exercise apparatus 100 will now be described with reference to FIGS. 1A through 1F. The multi-function joint rehabilitation and exercise apparatus 100 comprises mechanisms for holding the user's leg, applying force against lower limb extremity movement about the user's joint, moving the user's lower extremity, and applying force to the user's joint, all while monitoring feedback from the apparatus so as to adjust the movement of or force applied to or about the user's lower extremity and joint.

FIG. 1A shows the components of the multi-function joint rehabilitation and exercise apparatus 100 according to an example embodiment. The multi-function joint rehabilitation and exercise apparatus 100 includes a chair 102 where the user can sit comfortably, further including a seat 102a, a backrest 102b and four legs 102c. Under the seat is a base 103, from which protrudes an arm 113. Hingably attached to the arm 113 is an assembly 104 configured to securely hold the user's lower limb, such as his leg. The assembly is attached to the arm via a hinge 105. The assembly includes a footrest 104a hingably coupled to the assembly via a hinge 104c. In another embodiment, the device has no chair, but the device is attachable to any chair.

The assembly also includes an ankle holder 104b for holding the user's ankle. The ankle holder allows the leg to rotate at the knee and move with the lower leg assembly. The footrest 104a is used to rotate the ankle while the ankle holder is used to stabilize the leg during those ankle exercises. The device 104a can apply a compressive or tensile force to the knee, ankle, and lower leg via one or more motors 104d with or without gear reduction or other torque amplification methods. The magnitude, frequency, and speed of the force can be controlled by the user via the interface 119. The device 100 may also perform movement of the ankle, such as plantarflexion, dorsiflexion, inversion, eversion, pronation, supination, abduction, adduction, internal rotation, and external rotation, by moving the footrest about the hinge 104c via one or more motors 104e. The device 100 can provide range of motion, stretching, strengthening, joint manipulation, joint mobilization, manual therapy, joint loading, and weight-bearing functionality to the ankle joint and manipulation and mobilization to the patella for patella gliding and compression using the aforementioned mechanisms. The motors and sensors may also be used to adjust it to account for leg length, that is, the motors can change the orientation and length of the components of the device to account for longer or shorter legs.

The device 100 may also move the assembly about the hinge 105 via one or more motors 104f with or without gear reduction or other torque amplification methods, which can flex and extend the knee joint within a certain range of motion or provide variable resistance and passively resist knee motion for muscle strengthening exercises. One or more motors with or without gear reduction or other torque amplification methods, such as linear actuators, a combination of linear actuators and linkage, or rotary actuators (e.g., DC, AC, stepper motors, servomotors, gear motors, pneumatic/hydraulic actuators, motors coupled with a gearbox, actuators coupled with a gearbox) may move the assembly about the hinge 105. In addition, several mechanisms may interact with the linear actuator, such as belt or chain driven mechanisms, rail driven mechanisms, screw driven mechanisms, pneumatic or hydraulic piston driven mechanisms, slider and crank mechanisms, direct driven mechanisms with gear-trail or magnetic devices, chain and sprocket mechanisms, belt and pulley mechanisms. The user can control the speed, degrees of motion, and amount of force about the hinge 105 and the magnitude, frequency, range, and speed of resistance using the interface 119.

The one or more motors 104f with or without gear reduction or other torque amplification methods may be configured to apply force against the movement of the lower limb about the joint. In this case, if a user attempts to move his lower leg upwards, the apparatus 100 applies a force downwards, and vice versa. The one or more motors 104d with or without gear reduction or other torque amplification methods may also be configured to apply force to move the user's lower limb in a given direction.

Additionally, the device 100 can use a combination of one or more motors with or without gear reduction or other torque amplification methods. For example, one or more motors 104d with or without gear reduction or other torque amplification methods may be used to apply compressive or tensile force to the knee, ankle, and lower leg at a single, varying, or multitude of amplitudes and/or frequencies while at a single, varying, or multitude of knee joint degrees moved about the hinge 105 via one or more motors 104f with or without gear reduction or other torque amplification methods. This could be used for example for joint manipulation or mobilization at a specific location where the patient is experiencing osteoarthritis or to teach a patient weight-bearing percentages.

In another embodiment, one or more motors 104e with or without gear reduction or other torque amplification methods can move the footrest about the hinge 104c for movement of the ankle, such as plantarflexion, dorsiflexion, inversion, eversion, pronation, supination, abduction, adduction, internal rotation, or external rotation while at a single, varying, or multitude of knee joint degrees moved about the hinge 105 via one or more motors 104f with or without gear reduction or other torque amplification methods. This can be used for example for stretching such as dorsiflexion of the ankle with extension of the knee for hamstring and calf stretches.

In another example, one or more motors 104d with or without gear reduction or other torque amplification methods may be used to apply compressive or tensile force to the knee, ankle, and lower leg at a single, varying, or multitude of amplitudes and/or frequencies while providing variable resistance and passively resisting knee motion for muscle strengthening exercises via one or more motors 104f with or without gear reduction or other torque amplification methods. This could be used for example for closed kinetic chain exercises or weight-bearing strengthening exercises.

In one embodiment, the one or more motors 104f can be located within the base 103 and is connected to the hinge 105 via a chain/sprocket assembly that is configured to rotate the lower limb about the hinge. In this embodiment, the mechanical means connects the hinge to the one or more motors 104f. Other mechanisms may interact with the actuator, such as belt or chain driven mechanisms, rail driven mechanisms, screw driven mechanisms, pneumatic or hydraulic piston driven mechanisms, slider and crank mechanisms, direct driven mechanisms with gear-trail or magnetic devices, or belt and pulley mechanisms.

In another example, one or more motors 104d with or without gear reduction or other torque amplification methods may be used to apply compressive or tensile force to the knee, ankle, and lower leg at a single, varying, or multitude of amplitudes and/or frequencies while performing movement of the ankle, such as plantarflexion, dorsiflexion, inversion, eversion, pronation, supination, abduction, adduction, internal rotation, and external rotation, by moving the footrest about the hinge 104c via one or more motors 104e. This could be used for example for joint manipulation or mobilization at a specific location or to teach a patient weight-bearing percentages while they are moving their ankle and foot.

Protruding from the arm 113 of the multi-function joint rehabilitation and exercise apparatus 100 is an interface holder 109, designed to securely position and support the user interface 119. The interface holder 109 extends outward from the arm, typically at an angle, ensuring that the user can comfortably access and interact with the interface during their rehabilitation session. The holder is configured to be both sturdy and flexible, allowing the interface to be easily positioned within the user's reach, regardless of their seated posture or limb position. The user interface 119 is mounted on the holder 109, providing a centralized control panel for the user to interact with the apparatus. The user interface 119 enables the user to input commands, adjust exercise parameters such as resistance, range of motion, speed, weight-bearing forces, forces to the joint, forces about the joint, and force and movement frequencies, and view real-time feedback from the sensors embedded in the apparatus. Additionally, the interface can display critical information such as force measurements, joint angles, movement patterns, or exercise progress. The positioning of the interface holder ensures that the interface remains easily accessible throughout the entire therapy session, minimizing the need for the user to reposition themselves to interact with the controls.

The interface holder 109 may also feature mechanisms that allow for slight adjustments, such as swiveling or tilting, giving the user even greater control over how they interact with the device. This ergonomic design feature helps to create a seamless and user-friendly experience, allowing the user to focus on their rehabilitation while the interface facilitates smooth interaction with the apparatus.

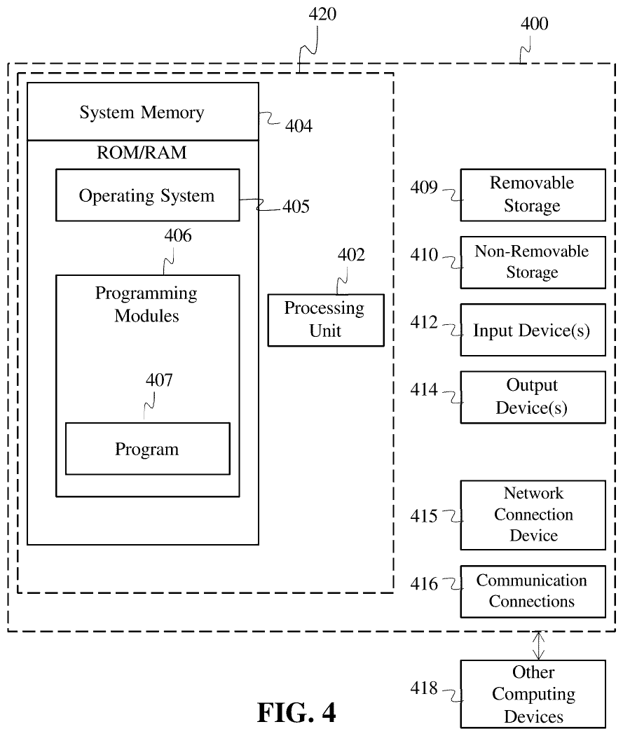

FIG. 1G is a block diagram showing the components of the exemplary multi-function joint rehabilitation and exercise apparatus 100, according to an example embodiment. FIG. 1G shows that the apparatus 100 includes a computing device 120, which is described in more detail with reference to FIG. 4 below. FIG. 1G also shows that the computing device 120 is communicatively coupled to a transceiver 124 for sending and receiving data, a plurality of sensors 126 for embedded in the apparatus, including at least a sensor for measuring force, a sensor for measuring position, and a sensor for measuring an angle, as well as the user interface 119. The computing device 120 is also communicatively coupled to one or more motors with or without gear reduction or other torque amplification methods for moving various components of the apparatus 100. A power supply 122 provides power to the components of apparatus 100. The transceiver 124 is configured for sending and receiving data wirelessly to external devices, such as computing device 131. The measurement data may be stored to the user's record for easy tracking of compliance, progress, and outcomes over time.

FIG. 1G also shows that the computing device 120 is communicatively coupled to motors 128 with or without gear reduction or other torque amplification methods, which may be at least three distinct motors that play essential roles in facilitating the various rehabilitation exercises, joint mobilizations, and joint manipulations. Each motor is strategically positioned within the apparatus 100 to optimize its function while ensuring user comfort and precision during the therapy sessions.

The first motor with or without gear reduction or other torque amplification methods is responsible for applying force against the lower limb extremity movement about the user's joint. Said first motor is located within the assembly 104 or within the base 103 with a mechanism that connects to assembly 104, which securely holds the user's lower limb. Specifically, it is attached to a hinge mechanism that allows for movement around the knee or ankle joint, a critical point in the rehabilitation process. This motor, typically an electric motor such as a DC or stepper motor, or actuator such as a linear or rotary actuator, generates force that acts in opposition to the user's attempt to move their limb or requires a force threshold to be applied before it will allow movement. For example, if the user tries to extend their leg or foot, the motor applies resistance to counteract this movement, mimicking the effect of weighted resistance exercises. The motor operates by controlling the torque applied to the hinge 105 or 104c, adjusting the resistance level based on feedback from the sensors embedded in the apparatus 100. This resistance can be modified in real-time to suit the user's specific rehabilitation needs, allowing for both passive and active resistance exercises. In one embodiment, the motor is locked at a position unless the force sensors detect a threshold amount of force applied by the user, after which, in response, the motor will apply a predefined force against the user's movement.

The second motor with or without gear reduction or other torque amplification methods is tasked with moving the user's joint such as the knee or ankle. This motor is also embedded within the assembly 104 or within the base 103 with a mechanism that connects to assembly 104, specifically attached to a hinge mechanism that allows for movement around the joint such as the knee or ankle joint. This motor can be a rotary motor or linear actuator, depending on the precise range of motion needed for the therapy. It generates the force necessary to move the joint such as the knee or ankle, providing movement assistance or no assistance but counteracting the weight of the leg and leg assembly 104 in exercises that require flexion and extension of the joint such as the knee or ankle, as well as movements such as dorsiflexion, plantarflexion, inversion, eversion, pronation, supination, abduction, adduction, internal rotation or external rotation of the ankle. By actively moving the user's ankle, this motor assists in range of motion or stretching exercises, particularly for users who are unable to perform these movements independently. The motor's speed, movement, force, and range of motion can be finely controlled via the user interface 119, ensuring that the movement is performed smoothly and within the user's comfortable range or within the clinician's restrictions. Additionally, feedback from the sensors continuously informs the motor to adjust the movement's intensity based on real-time data.

The third motor with or without gear reduction or other torque amplification methods in the apparatus 100 is responsible for applying force directly to the user's joint. This motor is also located within the assembly 104 or within the base 103 with a mechanism that connects to assembly 104 but is more closely associated with mechanisms that act directly on the knee joint. Attached to the assembly holding the lower limb and the arm 103, this motor can apply compression or distraction forces to the joint itself. Typically, a linear or rotary actuator is used for this purpose, allowing precise control over the amount of force applied along or about the axis of the knee joint or to the knee joint. This functionality is particularly useful for joint mobilization and manipulation therapies, where controlled force application can help improve joint health by stimulating cartilage regeneration or reducing inflammation. It's also been shown to protect chondrocytes against mechanical injury and/or Osteoarthritis inflammatory conditions, decrease the expression of inflammatory cytokines within articular cartilage, reduce nociceptive pain by activation of monoamine receptors, improve synovial fluid, and improve blood circulation. The motor works by generating axial force along the tibia, either compressing or gently pulling the joint, and it is capable of adjusting the load dynamically based on feedback from the sensors monitoring joint angle and force exerted. This is also useful for weight-bearing exercises, closed kinetic chain exercises, and joint manipulation. Additionally, this is useful for patella mobilization or manipulation where the motor works by applying force to the patella for patella gliding and compression.

To monitor various aspects of the exercise or rehabilitation session, the sensors 126 are capable of collecting measurement data regarding force exerted by various components of the apparatus 100, force exerted by the user, the position of the limb, the position of the joint, and the angle at which the joint is positioned. The computing device is configured to collect said measurement data from the sensors during use of the apparatus, store said data and transmit said data either during or after the session. The computing device is further configured to read said measurement data in real-time as feedback. Based on this feedback, the apparatus 100 may adjust the force applied against the lower limb's movement, move the lower limb, adjust the force applied to the joint, and/or manipulate the joint. This ensures a more tailored and effective rehabilitation or exercise session and allows for reliable and accurate measurements of the user's range of motion and strength, replicating goniometers, manual muscle testing, dynamometers, isokinetic testing, isometric testing, and isotonic testing.

A variety of sensors 126 may be used, such as a load cell to measure force. Alternatively, a strain gauge can also be used to measure force. For measuring the position of the limb, one or more displacement sensors, an inertial measurement units, or encoders may be used. To measure the angle of the joint, one or more rotary encoders or an inertial measurement units may be used. Alternatively, one or more potentiometers, hall effect sensors, electrical conductivity, accelerometers, or cameras/LiDAR may be used.

The computing device 120 may include software with a variety of different functionalities. Said software may include treatment plans, restrictions, and goals, as well as the ability to monitor progress toward said plans and goals and/or limit exercises to within restrictions. Said software may also have the capability for remote operation and data access, with embedded privacy and security measures in compliance with healthcare regulations. Said software may further includes algorithms that control the amplitude, velocity, patterns, and frequencies of prescribed movements within a set protocol.

Said software may include algorithms such as machine learning algorithms that monitor, modify, and control the compression and tensile load magnitude based on the anthropometrics and range of motion of the knee and ankle and the position of the knee and ankle. These algorithms estimate leg weight, center of mass, and moment of inertia, and then modify and control the loading conditions based on the input of the therapy protocol. They also can estimate physical properties of the leg based on the sensor measurements such as tissue composition, stiffness, weakness, swelling, scar tissue, strength, etc.

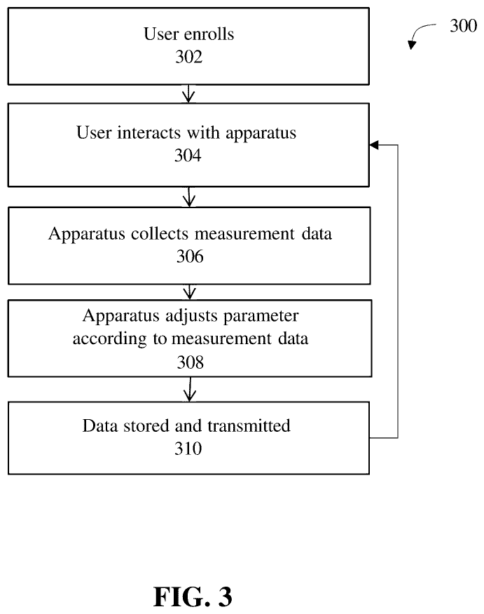

FIG. 3 is a flow chart depicting the general control flow of a process 300 for utilizing the multi-function joint rehabilitation and exercise apparatus, according to one embodiment. The process of the disclosed embodiments begins with optional step 302 (see flowchart 300), wherein the user may enroll or register with an online system. In the course of enrolling or registering, the users may enter data 202 into the user interface 119 by manually entering said data. In the course of enrolling or registering, the users may enter any data that may be stored in a user record, such as user name, address, birth date, height, weight, medical conditions, etc.

Next, in step 304, the user interacts with the apparatus 100 by performing different movements or exercises, wherein in step 306 the apparatus 100 collects measurement data 204, as described above, during use of the apparatus 100. Said measurement data 204 may be collected by the apparatus 100 in real time such that it is used in step 308 to modify the parameters such as the forces, speeds, and/or positions that are applied by the motors 128 with or without gear reduction or other torque amplification methods to various components of the apparatus 100. In step 310, said measurement data 204 may be transmitted to a user device 131, as well as to other devices, such as device 132, or back to the user interface 119 such that it may be viewed by a healthcare professional. The healthcare professional may view objective patient data remotely and gain new insights that can allow the professional to alter the patient treatment plan. For example, if the healthcare professional views that the force data is increased at certain degrees, it may be indicative of muscle tightness or scar tissue. The healthcare professional can use this force data to train therapists on how much force must be applied to a patient's leg at certain ranges to be able to further gain range of motion. In another example, the healthcare professional can compare the muscle strength of the quadriceps and hamstrings or to the contralateral leg to determine if the patient is ready to progress to the next stage of rehabilitation. Also, the healthcare professional can measure muscle forces while moving the leg during isokinetic testing to see how the angle affects the strength of the muscle.

The multi-function joint rehabilitation and exercise apparatus can also perform clinical measurements, such as assessing range of motion and muscle strength. Range of motion, typically measured using a goniometer, can be recorded by the apparatus through its embedded sensors that monitor joint angles and movement. Muscle strength, which is traditionally measured using manual muscle testing or a dynamometer, can be quantified by the apparatus during various types of exercises. Specifically, the apparatus can measure muscle strength during isokinetic, isometric, and isotonic exercises or movements, providing valuable data for static, dynamic, active, and passive exercises.

Additionally, the apparatus is capable of extracting data related to the amount of force needed to move a limb. This is significant for measuring the force required to overcome resistance in joint movement caused by scar tissue, stiffness, or other limitations. Currently, there is limited research on quantifying the force applied to enhance joint range of motion, as this is typically assessed manually by a therapist applying force with their hands. The apparatus addresses this gap by using pressure sensors to capture precise force data and to monitor the distance required to move the joint. This data provides a new layer of insight for rehabilitation, allowing for more accurate and objective measurements of patient progress.

The claimed embodiments allows for stretching of the muscles at the end of the range for quadricep and hamstring stretching or calf stretching. This could include proprioceptive neuromuscular facilitation (PNF) stretching, dynamic stretching, active stretching, passive stretching, or static stretching. For strengthening exercises, a force may be applied counter to the direction of leg movement, similar to a weight in a seated leg extension or curl. This allows for resistance strength training (isometric, isotonic, concentric, eccentric, isokinetic, open kinetic chain, closed kinetic chain). The force applied to the foot along the axis of the lower leg can be applied at the same time as the force counter to the direction of leg movement for a closed kinetic chain exercise or weight-bearing exercise. The force may also be applied to the foot along the axis of the lower leg counter to the direction of foot movement or about the ankle joint counter the direction of ankle rotation, similar to a seated calf raise with the ability to isolate the gastrocnemius or soleus muscles within the calf based on the angle of knee rotation during the calf raise. The claimed embodiments'sensing system can adjust the applied forces in real-time based on the user's performance, possibly preventing injury or allowing for more repetitions.

The claimed embodiment may also be used for quadricep seated leg extension strengthening, seated hamstring curl strengthening, quadricep stretching, hamstring stretching, range of motion knee extension, range of motion knee flexion, knee joint mobilization and manipulation (compression, distraction, gliding), patellar mobilization (gliding, compression), seated calf raise strengthening, calf stretching, ankle dorsiflexion, ankle plantar flexion, ankle inversion, ankle eversion, ankle pronation, ankle supination, ankle abduction, ankle adduction, ankle internal rotation, ankle external rotation, and ankle joint mobilization and manipulation (compression, distraction).

The one or more motors with or without gear reduction or other torque amplification methods 128 provide rotational movement of the lower leg around the axis of the knee joint. A sensor monitors the angle of joint rotation. Therapists can set the range of motion to ensure that the device delivers appropriate continuous passive motion within a targeted range or to allow the users to control passive, active assistive, or active motion and static or dynamic motion within a targeted range. The claimed embodiments allows for the delivery of passive range of motion (PROM), active range of motion (AROM), and/or active assisted range of motion (AAROM). Advanced algorithms control the amplitude and velocity of the lower leg's movement to assist in either extending or flexing the knee. These algorithms also enable the device to hold a stretch at the end of the range, which is particularly useful for stretching the quadriceps and hamstrings. Similar functionalities are available for exercises involving the ankle and calf.

The claimed embodiments incorporate sensing technology that allows for dynamic adjustments to the range of motion based on the user's comfort level on any given day. By monitoring the speed and pressure of the leg against the device, the apparatus 100 can determine when a user has reached the limit of their comfortable range. If the apparatus 100 detects reduced speed or increased pressure, it may indicate issues like muscle tightness or scar tissue, which could prevent the user from reaching their targeted range. In such cases, the apparatus 100 can apply additional force to help extend or flex the knee or ankle, mimicking the manual pressure a clinician would apply in a traditional setting. If the apparatus 100 senses that the resistance may be due to pain, it can prompt the user to adjust the exercise parameters accordingly. The apparatus 100 can also monitor the ankle position during knee movements to determine ankle stiffness which can be used for example to determine likelihood of knee or lower extremity injury or reinjury.

For strengthening exercises, the apparatus 100 may employ the same motor system but operates in reverse. A force is applied in the opposite direction of the leg's movement, similar to how weights work in traditional leg extension or curl exercises. The motor and/or linear actuator with or without gear reduction or other torque amplification methods generates a rotational tension force around the knee joint axis, aiding in the strengthening of the quadriceps during extension and the hamstrings during flexion. Similar functionalities are provided for strengthening exercises focused on the ankle. The computing device monitors the user's performance and adjusts the applied forces in real-time, allowing for safer and more effective exercises. This real-time adjustment can prevent potential injuries and allow for more repetitions by reducing or increasing the weight as needed.

The apparatus 100 may be configured to apply dynamic compression and stretching forces to the knee through an axial load along the tibia. The motors 128 with or without gear reduction or other torque amplification methods may compress the knee joint between the footrest and ankle holder. The apparatus 100 may also be used in reverse for stretching or gliding movements of the knee joint, to apply these forces at varying degrees of flexion or extension or during strengthening exercises for weight-bearing or closed kinetic chain strengthening exercises. Similar functionalities to the knee and ankle for exercises focused on the patella and ankle joints, respectively.

The therapies provided by the claimed embodiments are highly recommended for treating various lower extremity conditions and injuries. The claimed embodiments provide a variety of clinically relevant exercises for the lower extremity, such as seated leg extensions and curls, strengthening exercises, range of motion exercises, stretching exercises, weight-bearing exercises, joint manipulation, and joint mobilization techniques. These exercises are adjustable and aligned with natural biomechanics, similar to standard therapy exercise equipment and methods.

The claimed embodiments are also designed to be portable and lightweight, with a minimalistic design that makes it easy to distribute and keep in training locations. The claimed embodiments aim to remove scheduling and location barriers, enabling users to have easier access to high-quality care. The claimed embodiments'reliable data tracking can aid in clinical decision-making and determining a user's readiness to return to sports or duty. The claimed embodiments provide a comprehensive solution for joint rehabilitation and exercise, particularly for the lower extremities. The claimed embodiments integrate advanced technologies like artificial intelligence to offer personalized, high-quality care that can be accessed remotely, thereby expanding the reach of medical care and empowering patients for faster recovery.

FIG. 4 is a block diagram of a system including an example computing device 400 and other computing devices. Consistent with the embodiments described herein, the aforementioned actions performed by 131, 120 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for devices 120, 131 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g., random-access memory (RAM)), non-volatile (e.g., read-only memory (ROM)), flash memory, or any combination or memory. System memory 404 may include operating system 405, and one or more programming modules 406. Operating system 405, for example, may be suitable for controlling computing device 400′s operation. In one embodiment, programming modules 406 may include, for example, a program module 407 for executing the actions of 131, 120. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g., program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods'stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A multi-function joint rehabilitation and exercise apparatus, comprising:
a) a device comprising an assembly for accommodating a lower limb extremity such that said lower limb extremity rests securely within said assembly, an electric motor for applying force against lower limb extremity movement about the user's joint, an electric motor for moving the user's lower extremity, and an electric motor for applying force to the user's joint;
b) a plurality of sensors embedded in the device, including at least a sensor for measuring force, a sensor for measuring position, and a sensor for measuring an angle; and
c) a computing device comprising at least a processor and a memory, the computing device configured for collecting measurement data from the plurality of sensors, storing said measurement data and transmitting said measurement data during and after use of the apparatus by the user.

2. The apparatus of claim 1, wherein the sensor for measuring force comprises a load cell.

3. The apparatus of claim 1, wherein the sensor for measuring position comprises a displacement sensor.

4. The apparatus of claim 1, wherein the sensor for measuring an angle comprises a rotary encoder.

5. The apparatus of claim 1, wherein the computing device is further configured for reading the measurement data as feedback during use of the apparatus and adjusting force applied by the motor for applying force against lower limb extremity movement about the user's joint.

6. The apparatus of claim 1, wherein the computing device is further configured for reading the measurement data as feedback during use of the apparatus and adjusting force applied by the motor for moving the user's lower extremity.

7. The apparatus of claim 1, wherein the computing device is further configured for reading the measurement data as feedback during use of the apparatus and adjusting force applied by the motor for applying force to the user's joint.

8. The apparatus of claim 1, wherein the computing device is further configured for reading the measurement data as feedback during use of the apparatus and adjusting force applied by the motor for applying force against lower limb extremity movement about the user's joint, the motor for moving the user's lower extremity, and the motor for applying force to the user's joint.

9. The apparatus of claim 1, wherein the computing device further comprises a radio frequency transmitter for transmitting said measurement data wirelessly during and after use of the apparatus by the user.

10. The apparatus of claim 1, wherein the device comprises a seat for a user attached to the assembly.

11. A multi-function joint rehabilitation and exercise apparatus, comprising:
a) a device comprising an assembly for accommodating a lower limb extremity such that said lower limb extremity rests securely within said assembly, an electric motor for moving the user's lower extremity and an electric motor for applying force to the user's joint;
b) a plurality of sensors embedded in the device, including at least a sensor for measuring force, a sensor for measuring position, and a sensor for measuring an angle; and
c) a computing device comprising at least a processor and a memory, the computing device configured for collecting measurement data from the plurality of sensors, storing said measurement data and transmitting said measurement data during and after use of the apparatus by the user.

12. The apparatus of claim 11, wherein the sensor for measuring force comprises a load cell.

13. The apparatus of claim 11, wherein the sensor for measuring position comprises a displacement sensor.

14. The apparatus of claim 11, wherein the sensor for measuring an angle comprises a rotary encoder.

15. The apparatus of claim 11, wherein the computing device is further configured for reading the measurement data as feedback during use of the apparatus and adjusting force applied by the motor for applying force to the user's joint, and the motor for moving the user's lower extremity.

16. The apparatus of claim 11, wherein the computing device further comprises a radio frequency transmitter for transmitting said measurement data wirelessly during and after use of the apparatus by the user.

17. The apparatus of claim 11, wherein the device comprises a seat for a user attached to the assembly.

18. A multi-function joint rehabilitation and exercise apparatus, comprising:
a) a device comprising an assembly for accommodating a lower limb extremity such that said lower limb extremity rests securely within said assembly, an electric motor for applying force against lower limb extremity movement about the user's joint, and an electric motor for applying force to the user's joint;
b) a plurality of sensors embedded in the device, including at least a sensor for measuring force, a sensor for measuring position, and a sensor for measuring an angle; and
c) a computing device comprising at least a processor and a memory, the computing device configured for collecting measurement data from the plurality of sensors, storing said measurement data and transmitting said measurement data during and after use of the apparatus by the user.

19. The apparatus of claim 18, wherein the computing device is further configured for reading the measurement data as feedback during use of the apparatus and adjusting force applied by the motor for applying force against lower limb extremity movement about the user's joint, and the motor for applying force to the user's joint.

20. A multi-function joint rehabilitation and exercise apparatus, comprising:
a) a device comprising an assembly for accommodating a lower limb extremity such that said lower limb extremity rests securely within said assembly, an electric motor for applying force against lower limb extremity movement about the user's joint, and an electric motor for moving the user's lower extremity;
b) a plurality of sensors embedded in the device, including at least a sensor for measuring force, a sensor for measuring position, and a sensor for measuring an angle; and
c) a computing device comprising at least a processor and a memory, the computing device configured for collecting measurement data from the plurality of sensors, storing said measurement data and transmitting said measurement data during and after use of the apparatus by the user.
